(19) United States
(12) Patent Application Publication
(10) Pub. No.: US 2003/0230849 A1
(43) Pub. Date: Dec. 18, 2003

(54) Sealing device with an integral encoder wheel

(75) Inventors: Angelo Vignotto, Torino (IT); Massimo Russo, Torino (IT)

Correspondence Address: MERCHANT & GOULD PC, P.O. BOX 2903, MINNEAPOLIS, MN, 55402-0903, US

(73) Assignee: SKF Industrie S.p.A., Torino (IT)

(21) Appl. No.: 10/430,511

(22) Filed: May 6, 2003

(30) Foreign Application Priority Data
Jun. 13, 2002 (IT) TO2002A000501

(51) Int. Cl. F16J 15/32

(52) U.S. Cl. 277/349

(57) ABSTRACT

Sealing device (1) with an integral encoder wheel (2), the device presenting a rotating shield (3) which is provided with a centrifugal tubular race (5), and with a flange (6) which is transverse to the centrifugal race (5) itself; a fixed shield (4) provided with an end portion (7) which faces the flange (6); a encoder wheel (2) which is integral to the rotating shield (3) and which is arranged outside the flange (6); and a radial sealing lip (11) which is integral to the fixed shield (4) and which is arranged in sliding contact with the centrifugal race (5), in relation to which it is orientated in an axially opposite direction; an axial blocking element (17) which extends in such a way as to be interposed between the said encoder wheel (2) and the end portion (7) of the fixed shield (4) in order to create a radial interference between the encoder wheel (2) and the end portion (7) themselves.

The present invention relates to a sealing device with an integral encoder wheel.

In general, sealing devices with integral encoder wheels of a well-known type comprise:

a first shield which is suitable for being force-fit onto a rotating race of a bearing, and which is provided with a centrifugal tubular race, and with a flange which is transverse to the centrifugal race itself;

a second shield which is suitable for being force-fit onto a non-rotating race of a bearing;

a encoder wheel which is integral to the first shield and which is arranged outside the flange; and

a radial sealing lip which is integral to the second shield and which is arranged in sliding contact with the centrifugal race, in relation to which it is orientated in an axially opposite direction.

Sealing devices of the kind described above suffer from some disadvantages in that the first and second shields can become accidentally separated from each other along the automatic assembly line for the sealing devices, or during the transport of the sealing devices themselves. The reassembly of the sealing devices is usually carried out by means of an assembly tool, which is not, however, capable of verifying that the radial lip is effectively arranged in sliding contact all the way around the centrifugal race, and any mistakes in arrangement relating to the radial lip and the centrifugal race can result in premature damage to and the rapid deterioration of the sealing characteristics of the sealing device.

The aim of the present invention is to produce a sealing device with an integral encoder wheel, which will be totally absent of the disadvantages described above.

According to the present invention a sealing device with an integral encoder wheel will be produced the device comprising:

a first shield which is provided with a centrifugal tubular race, and with a flange which is transverse to the centrifugal race itself,

a second shield which is provided with an end portion which surrounds the flange;

a encoder wheel which is integral to the first shield and which is arranged outside the flange; and

a radial sealing lip which is integral to the second shield and which is arranged in sliding contact with the centrifugal race, in relation to which it is orientated in an axially opposite direction;

the device being characterised by the fact that it comprises an axial blocking element which is interposed between the said encoder wheel and the said portion of the second shield in order to create a radial interference between the encoder wheel and the end portion themselves.

The invention will now be described with reference to the attached drawings, which illustrate a non-limiting form of embodiment of the present invention, and in which:

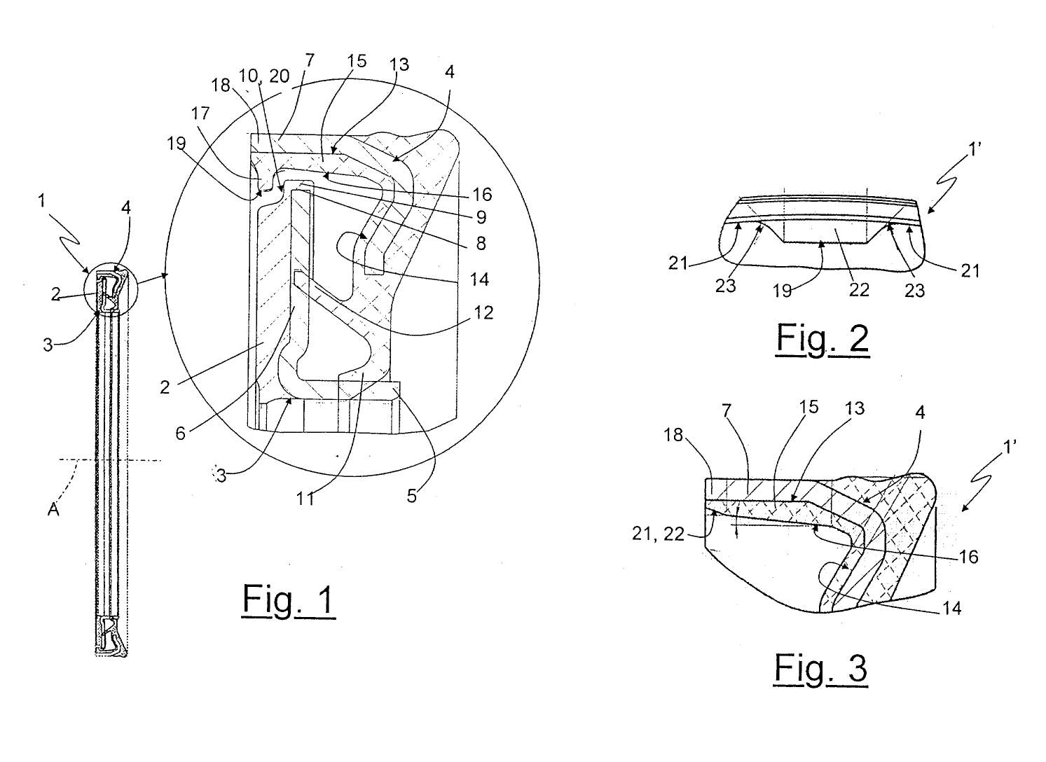

FIG. 1 illustrates an axial section view of a first preferred form of embodiment of a sealing device with an integral encoder wheel according to the present invention;

FIG. 2 illustrates, in frontal elevation and on an enlarged scale, with some parts removed for reasons of clarity, a second preferred form of embodiment of the device shown in FIG. 1; and

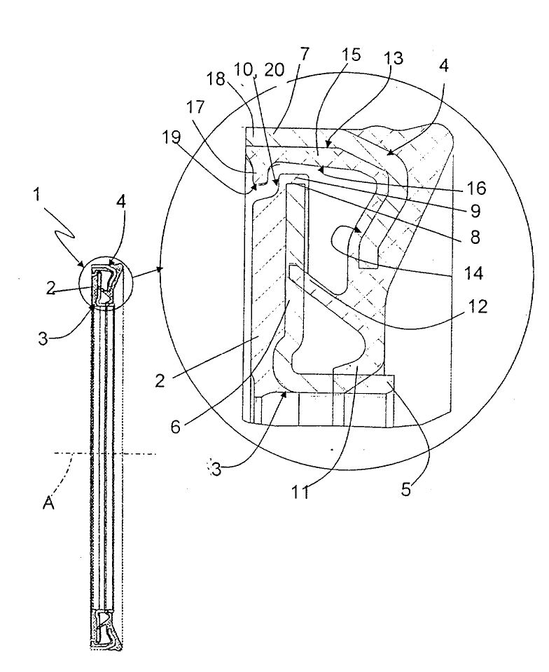

FIG. 3 illustrates a section along the line III-III shown in FIG. 2.

With reference to FIG. 1, the number 1 indicates a sealing device with an integral encoder wheel, in its entirety.

The device 1 comprises two shields 3 and 4, of which the shield 3 is a rotating shield which is provided with a centrifugal tubular race 5, and with a flange 6 which is transverse to the centrifugal race 5 itself, while the shield 4 is a fixed shield and is, in turn, provided with an end portion 7 which presents a tubular shape and which extends towards the outside of the flange 6 itself.

In particular, the race 5 is coaxially arranged in relation to a longitudinal axis A of the device 1, while the flange 6 radially extends towards the outside of the race 5 and is transverse to the axis A, and is radially delimited by a peripheral edge 8 which is arranged at a radial distance which is determined by the portion 7.

The encoder wheel 2 , being part of the device 1, is integral to the rotating shield 3, and is arranged outside the flange 6, and it comprises a lining portion 9 , which completely lines the edge 8 of the flange 6, and which defines a maximum external diameter Φ₁ of the encoder wheel 2 itself. The encoder wheel 2 also presents, in correspondence with the edge 8 an annular outlet 10, which is axially open towards the outside of the flange 6 and which is radially open towards the end portion 7, and which extends radially from the diameter Φ₁ and towards the inside of the encoder wheel 2 itself for a determined radial depth P_{R}.

The device 1 also comprises a radial integral sealing lip 11 which is integral to the fixed shield 4 and which is arranged in sliding contact with the centrifugal race 5 in relation to which it is orientated in an axially opposite direction, and an axial sealing lip 12 which is also integral to the fixed shield 4, and which is arranged in sliding contact with the flange 6.

The sealing device 1 also comprises an internal lining sealing lip of the fixed shield 4, which is arranged in such a way as to completely cover in sliding contact the centrifugal race 5 in relation to which it is orientated in an axially opposite direction, and an axial sealing lip 12, which is also integral to the fixed shield 4, and which is arranged in sliding contact with the flange 6.

Finally, the device 1 also comprises an internal lining 13 of the fixed shield 4, which is arranged in such a way as to completely cover an internal surface 14 of the fixed shield 4 itself, and which is made of rubber material as are the sealing lips 11 and 12.

The lining 13 comprises a tubular lining wall 15, which is intrinsically connected to the end portion 7, and which is radially delimited towards the inside by a surface 16 which is inclined towards the outside of th flange 6 in order to increase the effect of expelling any eventual impurities which might infiltrate between the fixed shield 4 and the rotating shield 3.

The lining 13 also comprises an axially blocking circumferential projection 17, which is interposed between the encoder wheel 2 and the end portion 7 in order to create a radial interference between the encoder wheel 2 and the end portion 7 themselves, and which is arranged in correspondence to a free axial end 18 of the end portion 7. The projection 17 extends radially towards the encoder wheel 2 and substantially inside the outlet 10 to a depth which is less that the depth Pᵣ but which is greater than the diameter Φ₁, and is radially delimited towards the inside by a conical surface 19 which tapers towards the outside of the flange 6 and which presents, at the minimum point of diameter, an internal diameter Φ₂ which is less than the diameter Φ₁.

In the form of embodiment of the device 1 which is illustrated in FIG. 1, the projection 17 is a continuous circumferential projection, and it defines with the outlet 10 a labyrinth annular duct 20 with a diameter which increases towards the inside of the device 1 and which is suitable for preventing the entry of any impurities into the device 1 itself.

The projection 17 is positioned substantially inside the outlet 10 in order to reduce an axial dimension of the device 1, but in the case that there are no problems relating to dimension the inclusion of the outlet 10 may also be omitted.

The form of embodiment which is illustrated in FIGS. 3 and 4 relates to a device 1′ which is similar to the device 1, from which the device 1′ differs due to the fact that the circumferential projection 17 is a discontinuous projection, and it presents six axial openings 21 (only two of which are illustrated) which are angularly spaced in relation to each other at an angle of 60°.

Each opening 21 is provided with a respective axial chute 22 which is created starting from the tubular lining wall 15, and which presents an inclination which is greater than the inclination of the surface 16.

The presence of the axial openings 21 permits the flow towards the outside of the device 1 of any dampness which might accumulate inside the device 1 itself, and the expelling effect created by the surface 16 also enhances the effect of expelling any eventual impurities which might have infiltrated, and also permits the openings 21 to be freed of any blockages caused by the impurities themselves.

A tooth 22 corresponds to each pair of adjacent axial openings 21, said tooth being radially delimited by the conical surface 19 and being attached to the bottom of each adjacent axial openings 21 themselves by means of the connecting surfaces 23 which present a determined radius of curvature.

It is intended that the present invention should not be limited to the form of embodiment herein described and illustrated, which is to be considered as a form of embodiment of a sealing device 1 with an integral encoder wheel 2, and which might be subject to further modifications relating to the shape and arrangement of its parts, as well as details pertaining to its construction and assembly.

1. Sealing device (1) with an integral encoder wheel (2), the device (1) comprising:
a first shield (3) which is provided with a centrifugal tubular race (5), and with a flange (6) which is transverse to the centrifugal race (5) itself,
a second shield (4) which is provided with an end portion (7) which surrounds the flange (6);
a encoder wheel 2) which is integral to the first shield (3) and which is arranged outside the flange (6); and
a radial sealing lip (11) which is integral to the second shield (4) and which is arranged in sliding contact with the centrifugal race (5), in relation to which it is orientated in an axially opposite direction;
the device (1) being characterised by the fact that it comprises an axial blocking element (17) which is interposed between the said encoder wheel (2) and the said portion (7) of the second shield (4) in order to create a radial interference between the encoder wheel (2) and the end portion (7) themselves.

2. Sealing device according to claim 1, characterised by the fact that the blocking element (17) comprises a circumferential projection (17) which is arranged along the axial end portion (7) and which presents an internal diameter (Φ₂) which is less than an external diameter (Φ₁) of the said encoder wheel (2).

3. Sealing device according to claim 2, characterised by the fact that the circumferential projection (17) is made of rubber material, and is integral to a tubular lining wall (15) of the second shield (4) and which is part of the second shield (4) itself.

4. Sealing device according to claim 3, characterised by the fact that the circumferential projection (17) is radially delimited towards the inside by a conical surface (19) which tapers towards the outside of the said flange (6).

5. Sealing device according to claim 4, characterised by the fact that the circumferential projection (17) is a continuous projection (17).

6. Sealing device according to claim 4, characterised by the fact that the circumferential projection (17) is a discontinuous projection (17) and it presents axial openings (21) which are spaced at an angle to each other, each of which is provided with a respective axial slide (22) which is produced starting from the said tubular lining wall (15).

7. Sealing device according to claims 5 or 6, characterised by the fact that the tubular lining wall (15) is radially delimited towards the inside by a surface (16) which is inclined towards the outside of the flange (6) in order to increase the effect of expelling any eventual impurities which might infiltrate between the first shield (3) and the second shield(4).

8. Sealing device according to claims 5 or 6, characterised by the fact that the encoder wheel (2) presents an annular outlet (10) which is open both axially and radially towards the outside, the said circumferential projection (17) being positioned substantially inside the annular outlet (10) in order to reduce the axial dimension of the sealing device (1) itself.
